(19) United States
(12) Patent Application Publication
(10) Pub. No.: US 2023/0054337 A1
(43) Pub. Date: Feb. 23, 2023

(54) PORTAL GEAR HUB WITH VENT BELLOWS

(71) Applicant: Super ATV, LLC, Madison, IN (US)

(72) Inventors: Justin L. Eaton, Hanover, IN (US); Jordan E. Stephan, Hanover, IN (US); Chris Shelton, Madison, IN (US)

(21) Appl. No.: 17/455,956

(22) Filed: Nov. 22, 2021

Related U.S. Application Data
(63) Continuation of application No. 17/411,087, filed on Aug. 25, 2021.
Application No. 17/411,087 is a continuation of application No. 17/407,202, filed on Aug. 20, 2021.

(51) Int. Cl. B60K 17/04; F16H 57/029; F16H 57/027; B60B 35/00

(52) U.S. Cl. CPC B60K 17/043; B60B 35/001; F16H 57/027; F16H 57/029; F16H 2057/02052

(57) ABSTRACT

A portal gear box assembly for an all-terrain vehicle includes a sealed portal gear box housing having an interior housing space that contains a set of gears for linking an axle to an output shaft. An expandable space is in fluid communication with the interior housing space, and is adapted to allow pressurized fluid contained in the interior housing space to flow into the expandable space, thus expanding the volume of the expandable space and reducing the pressure within the interior housing space. The expandable space may be provided in the form of a bellows whose volume can be changed by expansion or contraction of a fluid contained therein. A fluid is contained within the portal gear box housing and within the expandable space.

The expandable space may be mounted externally to the portal gear box housing, and may be connected to the portal gear box housing by a conduit effective for allowing fluid to pass between the portal gear box housing and the expandable space. The expandable space and its connecting conduit are effective for allowing air to flow from within the portal gear box housing to the expandable space when an increased air pressure within the portal gear box is encountered, thus mitigating against a build-up of air pressure within the portal gear box housing.

### REFERENCE TO RELATED APPLICATIONS

This application claims priority from U.S. Pat. Application No. 17/411,087, filed Aug. 25, 2021, which claims priority from U.S. Pat. Application No. 17/407,202, filed Aug. 20, 2021; the entire contents of the prior application being hereby incorporated herein by reference.

### FIELD OF THE INVENTION

The present invention relates generally to portal wheel ends for lifting the wheels of an off road vehicle, such as an all-terrain vehicle (ATV) or a utility task vehicle (UTV), and more particularly to gear-reducing portal gear boxes.

### BACKGROUND OF THE INVENTION

Portal gear lifts are used by ATV and UTV enthusiasts to raise an off-road vehicle higher above the ground so that larger tires can be run on the vehicle. In addition, since larger diameter tires cover a greater distance with each rotation, portal gear lifts typically include gear reduction so that a single rotation of the vehicle power axle results in a slightly lesser rotation of the output axle. Further, the extra length provided by the output axle may allow the assembly to widen the wheelbase of the vehicle.

Portal gear lifts typically include sealed housings (boxes) that contain a fluid lubricant effective to lubricate the gears as the gears spin within the housing. Vigorous use may cause the gears and their lubricant to heat, and that heating may reduce the effectiveness of the lubricant and cause pressure to build up within the housing. Additionally, excess heat may damage seals, causing them to fail and allowing oil, etc., to leak from the box.

A need therefore exists for materials and methods for reducing portal gear box heating, and for avoiding, reducing, and/or relieving resulting pressure. The present invention addresses that need.

### SUMMARY OF THE INVENTION

In one aspect of the invention there is provided a portal gear box assembly for an all-terrain vehicle or a utility task vehicle. The assembly may comprise a sealed portal gear box housing having an interior housing space defined by a rear wall, a front wall, and a side wall. The rear wall may include a vehicle axle opening for receiving the end of the stock vehicle axle, and the front wall may include an output shaft opening for receiving the end of an output shaft that powers the vehicle wheel. A set of gears is housed in the housing, and the gears are effective for linking the axle received in the vehicle axle opening to the output shaft received in the output shaft opening. Thus, the output shaft is operably connectable via the linking mechanism to the axle, and provides the appropriate gear reduction for the vehicle as configured.

To reduce pressure build-up in the gear box housing, the assembly further includes an expandable space in fluid communication with the interior housing space. The expandable space is adapted to allow pressurized fluid contained in the interior housing space to flow into the expandable space, thus expanding the volume of the expandable space and reducing the pressure within the interior housing space. In some embodiments the expandable space comprises a bellows whose volume can be changed by expansion or contraction of a fluid contained therein.

The expandable space may be mounted externally to the portal gear box housing. Most preferably, the expandable space is connected to the portal gear box housing by a conduit effective for allowing fluid to pass between the portal gear box housing and the expandable space.

A fluid is contained within the portal gear box housing and within the expandable space. In some preferred embodiments that fluid comprises air.

The expandable space and its connecting conduit may be adapted to allow air pressure within the portal gear box housing to be relieved by expansion of the interior volume of the expandable space. Accordingly, the expandable space and its connecting conduit are effective for allowing air to flow from within the portal gear box housing to the expandable space when an increased air pressure within the portal gear box is encountered, thus mitigating against a build-up of air pressure within the portal gear box housing.

### BRIEF DESCRIPTION OF THE DRAWINGS

FIG. 1 is a first side elevational view of one embodiment of the present invention.

FIG. 2 is a first perspective view of one embodiment of the present invention.

FIG. 3 is a second perspective view of one embodiment of the present invention.

FIG. 4 is a fourth perspective view of one embodiment of the present invention.

FIG. 5 is a first exploded view of one embodiment of the present invention.

FIG. 6 is a second exploded view of one embodiment of the present invention.

FIG. 7 is a third exploded view of one embodiment of the present invention.

FIG. 8 is a perspective view of another embodiment of the present invention.

FIG. 9 is a perspective view of another embodiment of the present invention.

### DESCRIPTION OF THE PREFERRED EMBODIMENTS

For the purposes of promoting an understanding of the principles of the invention, reference will now be made to certain embodiments and specific language will be used to describe the same. It will nevertheless be understood that no limitation of the scope of the invention is thereby intended, such alterations and further modifications in the described device, and such further applications of the principles of the invention as illustrated therein, being contemplated as would normally occur to one skilled in the art to which the invention relates.

As indicated above, one aspect of the present invention relates to a vehicle such as an all-terrain vehicle or a utility task vehicle, and more particularly to a gear lift assembly for such vehicles. The assembly may comprise a sealed portal gear box housing having an interior housing space defined by a rear wall, a front wall, and a side wall. The rear wall may include a vehicle axle opening adapted to receive the end of an axle of an all-terrain vehicle or a utility task vehicle, and the front wall may include an output shaft opening adapted to receive the end of an output shaft that is effective to power a vehicle wheel. A set of gears is housed in the housing, and the gears are effective for linking the axle received in the vehicle axle opening to the output shaft received in the output shaft opening. Thus, the output shaft is operably connectable via the linking mechanism to the axle, and provides the appropriate gear reduction for the vehicle.

The assembly further includes an expandable space in fluid communication with the interior housing space. The expandable space is adapted to allow pressurized fluid contained in the interior housing space to flow into the expandable space, thus expanding the volume of the expandable space and reducing the pressure within the interior housing space. In some embodiments the expandable space comprises a bellows whose volume can be changed by expansion or contraction of a fluid contained therein.

The expandable space may be mounted externally to the portal gear box housing. Most preferably, the expandable space is connected to the portal gear box housing by a conduit effective for allowing fluid to pass between the portal gear box housing and the expandable space.

A fluid is contained within the portal gear box housing and within the expandable space. In some preferred embodiments that fluid comprises air.

The expandable space and its connecting conduit may be adapted to allow air pressure within the portal gear box housing to be relieved by expansion of the interior volume of the expandable space. Accordingly, the expandable space and its connecting conduit are effective for allowing air to flow from within the portal gear box housing to the expandable space when an increased air pressure within the portal gear box is encountered, thus mitigating against a build-up of air pressure within the portal gear box housing.

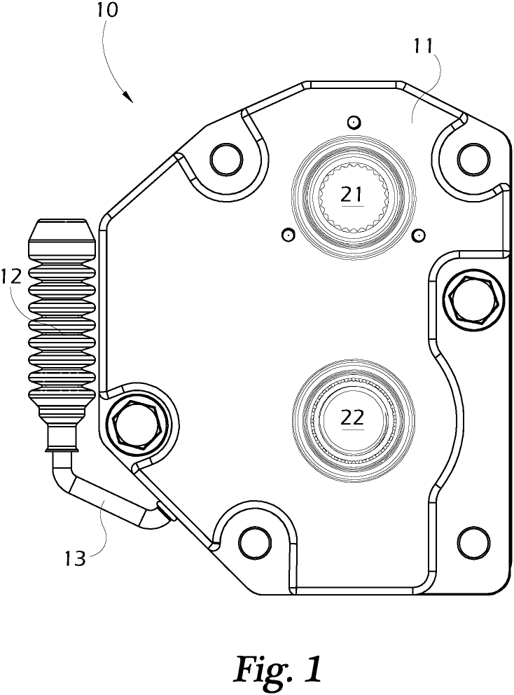

Referring now to the drawings, FIG. 1 is an elevational view of one embodiment of the present invention. Assembly 10 comprises a housing 11 and an external expandable space in the form of bellows 12. A conduit connect bellows 12 to the interior of housing 11. Openings 21 and 22 are provided for an input shaft and an output shaft, respectively.

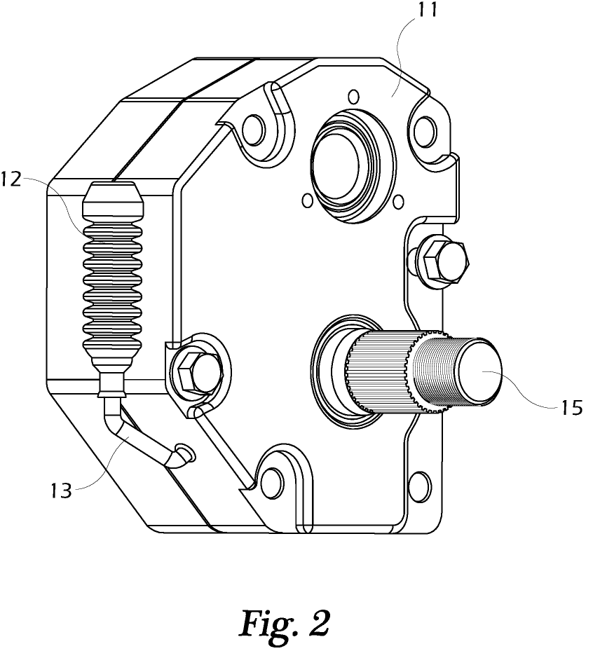

FIG. 2 is a perspective view of one embodiment of the present invention. Assembly 10 comprises a housing 11 and an expandable space in the form of bellows 12. A conduit 13 connect bellows 12 to the interior of housing 11. Output shaft 15 extends from output shaft opening 22 to power a wheel of the vehicle.

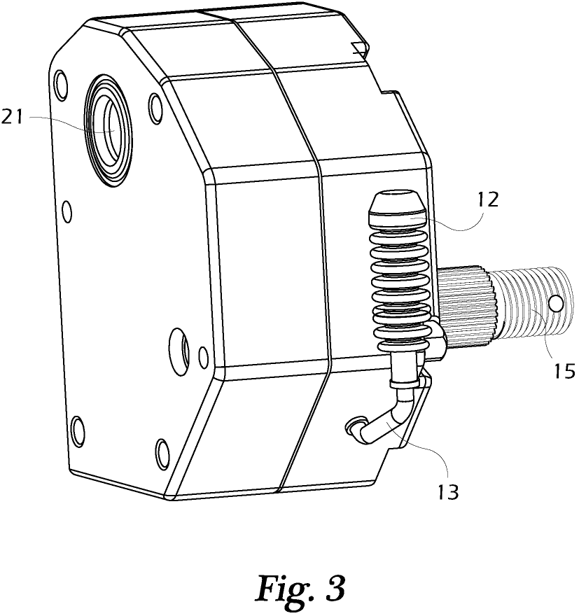

FIG. 3 is another perspective view of one embodiment of the present invention. Assembly 10 comprises a housing 11 and expandable space 12 in the form of a bellows. Conduit 13 connect bellows 12 to the interior of housing 11. Opening 21 is provided for an input shaft which is typically a vehicle axle.

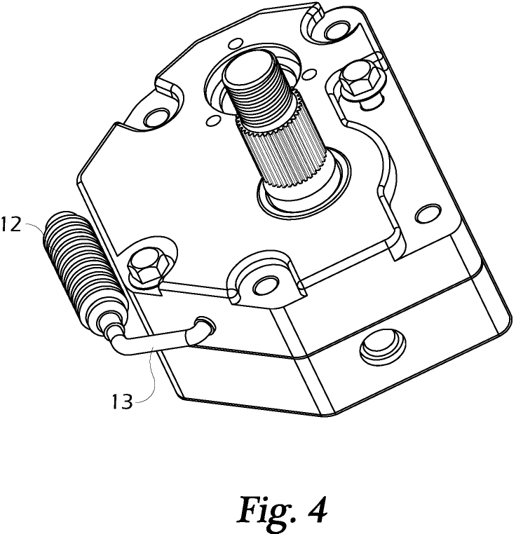

FIG. 4 is another perspective view of one embodiment of the present invention. Vent bellows 12 is provided to allow pressurized fluid contained in the interior housing space to flow into the expandable space, thus expanding the volume of the expandable space and reducing the pressure within the interior housing space. Conduit 13 connects bellows 12 to the interior of housing 11.

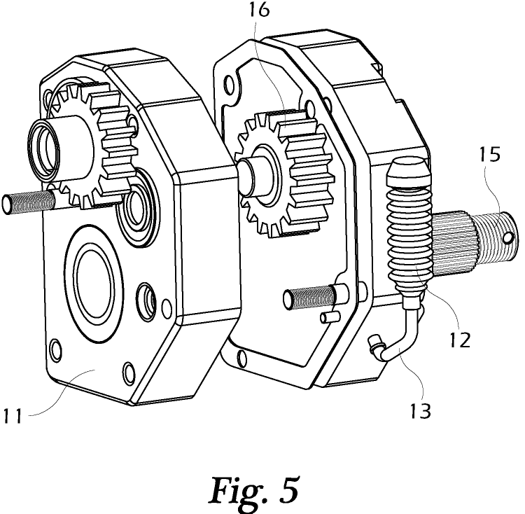

FIG. 5 is an exploded view of one embodiment of the present invention. Vent bellows 12 is provided to allow pressurized fluid contained in the interior housing space to flow into the expandable space, thus expanding the volume of the expandable space and reducing the pressure within the interior housing space. Conduit 13 connects bellows 12 to the interior of housing 11. Gears 16 are provided in the housing to king an axle received in the vehicle axle opening to an output shaft received in the output shaft opening. Output shaft 15 extends from output shaft opening 22 to power a wheel of the vehicle.

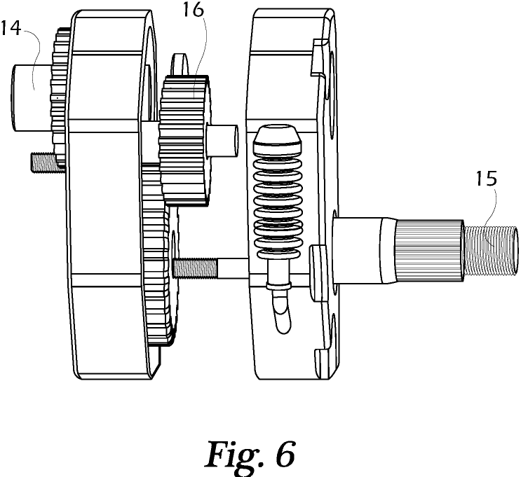

FIG. 6 is another exploded view of one embodiment of the present invention. Vent bellows 12 is provided to allow pressurized fluid contained in the interior housing space to flow into the expandable space, thus expanding the volume of the expandable space and reducing the pressure within the interior housing space. Conduit 13 connects bellows 12 to the interior of housing 11. Gears 16 are provided in the housing to king an axle received in the vehicle axle opening to an output shaft received in the output shaft opening. Input shaft 14 is received in input shaft opening 21, and connects with linking gears 16. Output shaft 15 extends from output shaft opening 22 to power a wheel of the vehicle.

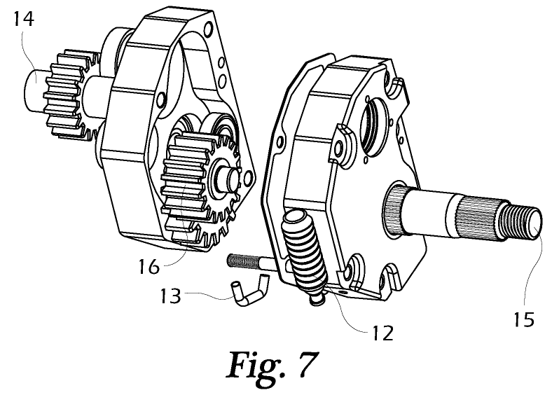

FIG. 7 is another exploded view of one embodiment of the present invention. Vent bellows 12 is provided to allow pressurized fluid contained in the interior housing space to flow into the expandable space, thus expanding the volume of the expandable space and reducing the pressure within the interior housing space. Conduit 13 connects bellows 12 to the interior of housing 11. Gears 16 are provided in the housing to king an axle received in the vehicle axle opening to an output shaft received in the output shaft opening. Input shaft 14 is received in input shaft opening 21, and connects with linking gears 16. Output shaft 15 extends from output shaft opening 22 to power a wheel of the vehicle.

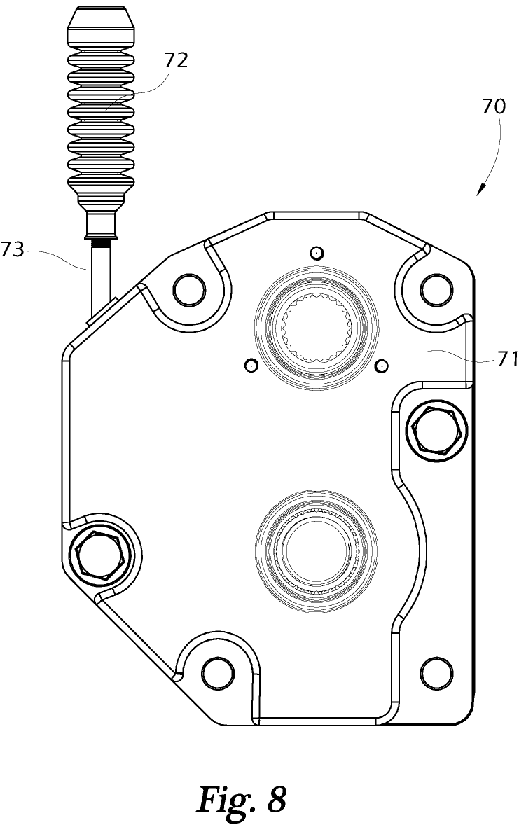

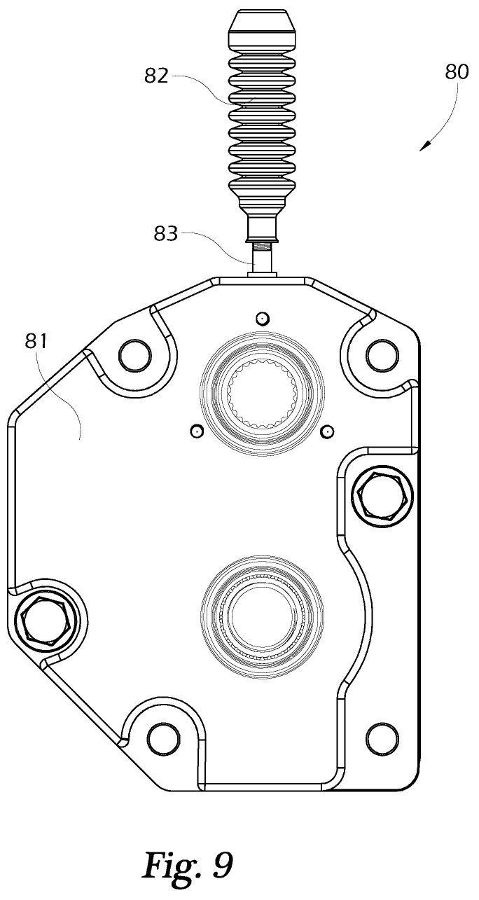

FIGS. 8 and 9 show embodiments with alternative placements of the expandable space. In both figures, the expandable space is provided so that the conduit enters the housing at a level higher than the level of the oil in the housing, with FIG. 8 showing the expandable space/vent bellows being positioned in the upper portion of the housing, and FIG. 9 showing the expandable space/vent bellows being positioned at the top of the housing.

In FIG. 8, assembly 70 comprises a housing 71 and an external expandable space in the form of bellows 72. A conduit 73 connect bellows 72 to the interior of housing 81.

In FIG. 9, assembly 80 comprises a housing 81 and an external expandable space in the form of bellows 82. A conduit 83 connect bellows 82 to the interior of housing 81.

While the invention has been illustrated and described in detail in the foregoing description and drawings, the same are to be considered as illustrative and not restrictive in character, it being understood that only certain preferred embodiments have been shown and described, and that all changes and modifications that come within the spirit of the invention are desired to be protected.

Additionally, it is to be appreciated that the present invention may comprise or consist essentially of any or all of the described ingredients in their disclosed amounts, and that any or all of the ingredients, amounts, features, elements, and/or embodiments disclosed herein may be combined with any or all of the other ingredients, amounts, features, elements, and/or embodiments disclosed herein to provide an invention that comprises or consists essentially of such ingredients, amounts, features, elements, and/or embodiments.

The grammatical device “and/or” (such as in “A and/or B”) is used in this disclosure to mean A alone, or B alone, or both A and B. Additionally, the term “substantially perpendicular” means within 5° of perpendicular, and the term “substantially forward” (or rearward) of perpendicular means at least 10° forward (or rearward) of perpendicular.

1. A portal gear box assembly for an off-road vehicle such as an all-terrain vehicle or a utility task vehicle, the assembly comprising:
a) a sealed portal gear box housing having an interior housing space defined by a rear wall, a front wall, and a side wall,
wherein the rear wall includes a vehicle axle opening effective to receive the end of an axle of an all-terrain vehicle or a utility task vehicle, and
wherein the front wall includes an output shaft opening effective to receive the end of an output shaft effective to power a vehicle wheel;
b) a set of gears housed in the housing and effective for linking an axle received in the vehicle axle opening to an output shaft received in the output shaft opening;
c) an output shaft operably connectable via said linking mechanism to an axle received in the vehicle axle receptacle, and effective to rotate upon rotation of the stock axle; and
d) an expandable space in fluid communication with the interior housing space and adapted to allow pressurized fluid contained in the interior housing space to flow into the expandable space, thus expanding the volume of the expandable space and reducing the pressure within the interior housing space;
wherein the expandable space comprises a bellows whose volume can be changed by expansion or contraction of a fluid contained therein;
wherein the expandable space is mounted externally to the portal gear box housing;
wherein the expandable space is connected to the portal gear box housing by a conduit effective for allowing fluid to pass between the portal gear box housing and the expandable space; and
wherein the externally mounted bellows is positioned to expand vertically with respect to the housing.

2-4. (canceled)

5. A portal gear box assembly according to claim 1 wherein a fluid contained within the portal gear box housing and within the expandable space comprises air.

6. A portal gear box assembly according to claim 5 wherein the expandable space and its connecting conduit are adapted to allow air pressure within the portal gear box housing to be relieved by expansion of the interior volume of the expandable space.

7. A portal gear box assembly according to claim 5 wherein the expandable space and its connecting conduit are effective for allowing air to flow from within the portal gear box housing to the expandable space when an increased air pressure within the portal gear box is encountered, thus mitigating against a build-up of air pressure within the portal gear box housing.
